(19) United States
(12) Patent Application Publication
(10) Pub. No.: US 2015/0032905 A1
(43) Pub. Date: Jan. 29, 2015

(54) METHOD AND SYSTEM FOR ASSOCIATING INTERNET PROTOCOL (IP) ADDRESS, MEDIA ACCESS CONTROL (MAC) ADDRESS AND LOCATION FOR A USER DEVICE

(71) Applicant: QUALCOMM Incorporated, San Diego, CA (US)

(72) Inventors: Leyla S. Celebi, San Diego, CA (US); George Joseph, San Diego, CA (US); Eric P. Bilange, San Diego, CA (US); Peter S. Marx, San Diego, CA (US); Cormac S. Conroy, Palo Alto, CA (US)

(73) Assignee: QUALCOMM Incorporated, San Diego, CA (US)

(21) Appl. No.: 13/949,335

(22) Filed: Jul. 24, 2013

(51) Int. Cl. H04L 29/12

(52) U.S. Cl. CPC H04L 61/2015
USPC 709/245

(57) ABSTRACT

A method for associating an Internet Protocol (IP) address, a media access control (MAC) address and a location for a user device includes receiving IP to DHCP (dynamic host configuration protocol) bindings related to a user device from a domain name server (DNS), receiving a MAC address related to the user device from the DNS, associating the IP address and the MAC address for the user device, using the MAC address to obtain a geographic location of the user device, building a table having the IP:MAC address association, the location of the user device and a timestamp corresponding to the IP:MAC address association and the location of the user device, and using the IP:MAC address association and the location of the user device to deliver contextual content to the user device.

### DESCRIPTION OF THE RELATED ART

Location-based services are becoming more and more prevalent. An example of a location-based service is the delivery of location-based context-aware content to a user of a mobile computing device, such as a smartphone, or other device, that is capable of accessing a website without using a third-party application. For example, a user of a mobile device enters a geographic area that is monitored by a network of wireless access points. Typically, the mobile device will connect to one of the wireless access points and gain access to the network. Such a network of wireless access points typically uses wireless fidelity (WiFi) as the underlying technology to allow the user to wirelessly connect to the network. An example of a WiFi network is one that is implemented according to one or more of IEEE 802.11b/g/n, or similar wireless access standards. The user of the mobile device uses a web browser on the mobile device to request a website associated with the entity that provides the network and the monitored area. The user then receives context-aware content based on, for example, the location of the user.

Generally, WiFi uses a Media Access Control (MAC) address that is assigned to each mobile device for identifying users and providing location-based services. However, an application layer entity will typically employ an Internet Protocol (IP) address as a way of identifying a mobile device. Unfortunately, a MAC address does not translate or correspond to an IP address at the application layer thus making it difficult to provide location-based services to the WiFi-connected mobile device at the application level. Therefore, to provide location-based services to a mobile device at the application layer, applications and services require a method of mapping an IP address to a MAC address.

### SUMMARY

Various embodiments of methods and systems for associating an Internet Protocol (IP) address, a media access control (MAC) address and a location for a user device are disclosed. An exemplary embodiment of a method for associating an Internet Protocol (IP) address, a media access control (MAC) address and a location for a user device, comprises receiving IP to DHCP (dynamic host configuration protocol) bindings related to a user device from a domain name server (DNS), receiving a MAC address related to the user device from the DNS, associating the IP address and the MAC address for the user device, using the MAC address to obtain a geographic location of the user device, building a table having the IP:MAC address association, the location of the user device and a timestamp corresponding to the IP:MAC address association and the location of the user device, and using the IP:MAC address association and the location of the user device to deliver contextual content to the user device.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an embodiment of a system and method for associating IP address, MAC address and location for a user device.

FIG. 2 is a functional block diagram of the position mapper of FIG. 1.

FIG. 3 is a call flow diagram illustrating an embodiment of a method for associating IP address, MAC address and location.

FIG. 4 is a block diagram of the domain name server of FIG. 1 and an example of an IP:DHCP binding table.

FIGS. 5A and 5B are a flow chart collectively illustrating an embodiment of a method for associating IP address, MAC address and location for a user device.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user device” and “client device” include a device capable of receiving content from a web site and transmitting information to a website. A user device or client device can be a stationary device or a mobile device. The terms “user device” and “client device” can be used interchangeably.

As used herein, the term “user” refers to an individual receiving content on a user device or on a client device and transmitting information to a website.

As used herein, the term “MAC address” and the term “MAC ID” refer to the media access control (MAC) identifier assigned to a device and can be used interchangeably.

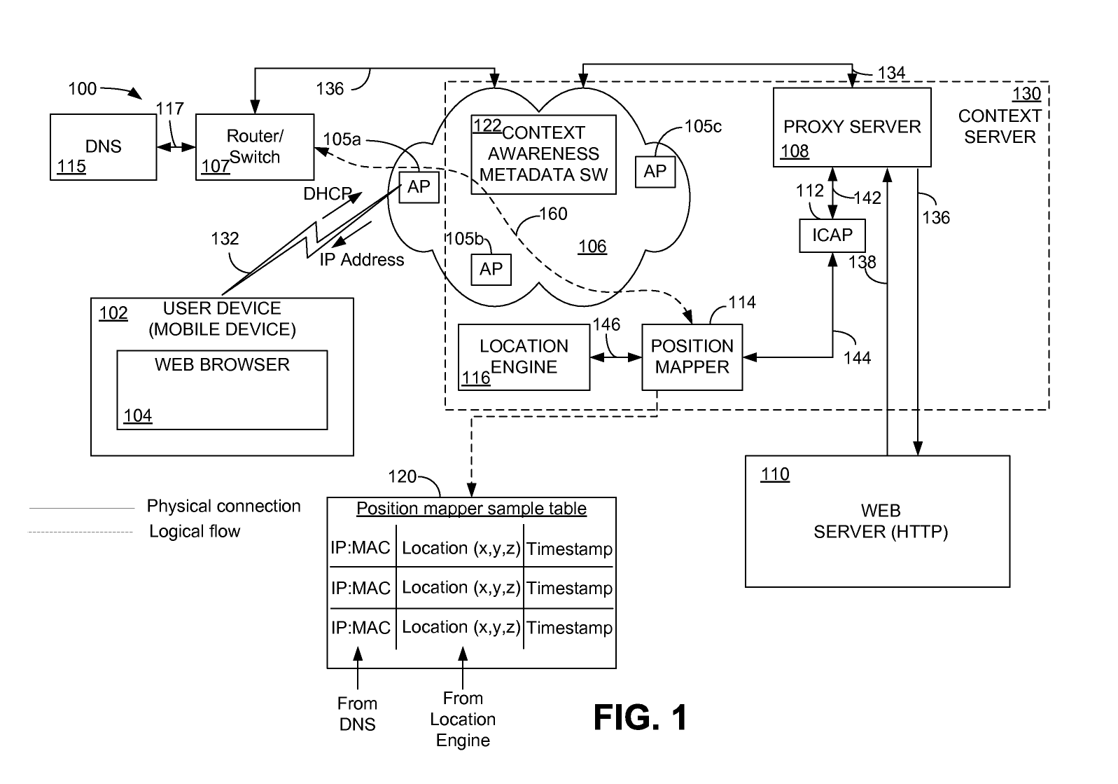

FIG. 1 is a functional block diagram of an embodiment of a system for associating IP address, MAC address and location for a user device. The system 100 comprises a user device 102, a network 106, a router/switch 107, a proxy server 108, a web server 110 and a domain name server 115. The user device 102 can be a stationary device or a mobile device, and is typically a mobile computing device including a browser 104, such as a hypertext transfer protocol (HTTP) web browser 104 for accessing and viewing web content. In an embodiment, the user device 102 is a mobile device, such as a smart phone that can connect to the Internet. The web server 110 can be an HTTP server.

In an embodiment, the network 106 comprises a network of access points 105 (each labeled “AP”). In an example, the mobile device 102 is wirelessly connected to the access point 105a using a connection in accordance with IEEE 802.11b/g/n, or another wireless access standard. The location of the user device 102 can be determined in a number of ways including, but not limited to, knowing the location of the access point to which the user device 102 is connected, algorithms that use radio parameters such as receive signal strength indication (RSSI), round trip time (RTT), to determine the location, GPS mapping, a combination of these, or another location determination technology.

The router/switch 107 comprises various functionality including, but not limited to, a router, a switch, and other functionality. The router/switch 107 is connected to the domain name server 115 over connection 117. The network 117 can be a LAN, a WAN, or another network. Moreover, although shown as separate elements, the router/switch 107 and the DNS 115 may reside inside of the network 106. The network 106 also comprises a software module 122. The software module 122 has logic for routing based on contextual parameters, and manages the flow of context aware metadata, in that it applies, appends, attaches, or otherwise associates metadata to an HTTP or HTTPS request received from the user device 102. In an implementation example, the software module 122 can comprise and manage the functionality provided by a proxy server 108, an Internet content adaptation protocol (ICAP) element 112, a position mapper 114 and a location engine 116, these elements being referred to as a “context server” 130. In an example, the metadata appended by the software module 122 identifies the context of the user device 102 and provides context aware metadata to the proxy server 108. The context aware metadata is appended to an HTTP or HTTPS request sent by the user device 102, the metadata defining, corresponding to, or otherwise identifying the context of the user device 102. The context of the user device 102 may be, for example, whether the user device is moving or stationary, the specific location of the user device, whether the user of the device is walking, shopping, driving, indoors, out of doors, etc. An example of providing location-based context aware content is a website tailoring content provided to a user based on whether, for example, the user is at one or another location determined by the location engine using the access points 105 or other IP based system in conjunction with the system and method for associating an IP address with a MAC address.

Depending on the implementation, the software module 122 manages one or more of the proxy server 108, ICAP element 112, position mapper 114, and the location engine 116 to identify the context of the user device 102 and provide, append, or otherwise associate context aware metadata as part of an HTTP or HTTPS request. The communication between the ICAP element 112 and the proxy server 108 provides a standard way for implementing HTTP header modification functionality.

The location engine 116 provides the current location of the user device 102. The location engine 116 can use one or more of triangulation, latency data, access point connection data, or other ways to detect the current location of the user device 102. Typically, a mobile device 102 is identified to the network 106 by a MAC address and is assigned an IP address. The IP address can be a dynamically assigned IP address.

In an embodiment, the position mapper 114 receives IP to DHCP bindings and MAC addresses related to the user device 102 from the DNS 115 via the router/switch 107 and network 106 over logical connection 160. Alternatively, the DNS 115 may be directly connected to the network 106, or the functionality of the router/switch 107 can be part of the network 106. The position mapper 114 receives location information related to the user device 102 from the location engine 116. The position mapper 114 uses the IP and MAC address association corresponding to the user device 102 to build a table 120, which includes IP to MAC address mapping (IP:MAC), a location fix for the user device 102, and a timestamp identifying the time corresponding to the location fix. In this manner, the position mapper 114, by using the DNS 115 to provide the IP:MAC address mapping in real-time, and the location engine 116 to provide device location based on MAC address, does not rely on any particular IP:MAC address mapping because it decouples the IP address of the user device 102 from the location determination technology. In an embodiment, the location of the user device 102 is determined using the MAC address of the user device 102. The IP to MAC address association is created from the IP to DHCP bindings and MAC addresses received from the DNS 115 and is maintained by the position mapper 114 so that requests from various application layers can include location information in a response. In an embodiment where the system is centralized and each AP has its own DHCP table, the mapping will also include AP information as well as MAC address and IP information to identify a user device 102 and its location.

In particular, the position mapper 114 takes the IP address of the user device 102, determines a MAC address for the user device 102 based on the IP address and the IP:MAC address mapping, and requests location information from the location engine 116 based on the MAC address of the user device 102. The position mapper 114 then returns the location information to the ICAP element 112, which requested contextual information for the user device 102 as part of the operation of the context awareness metadata software 122. In this manner, location information related to the user device 102 is sent to the ICAP element 112 from the position mapper 114, and the ICAP element 112 provides a modified HTTP header to the proxy server 108 with the location information of the user device 102. The proxy server 108 receives the modified header and provides a modified HTTP request to the web server 110, the modified request having the current location of the user device 102, thus allowing the web server 110 to provide contextual content to the user device 102 based on the location of the user device 102.

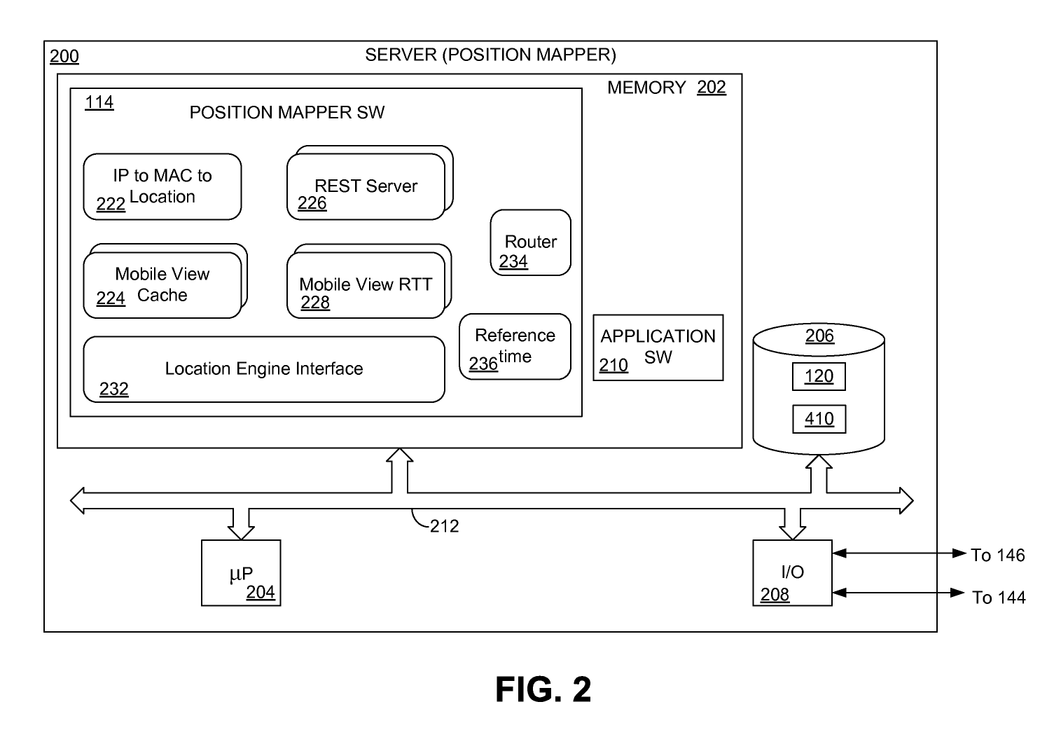

FIG. 2 is a functional block diagram of a computing device 200 that can be used to implement the position mapper 114 of FIG. 1. In an embodiment, the computing device 200 can be implemented as a stand-alone computing device, such as a server device. In an embodiment, the computing device 200 can be part or all of the context server 130 (FIG. 1).

In an embodiment, the computing device 200 comprises a memory 202, a processor 204, a database 206 and an input/output (I/O) element 208, operatively connected over a system bus 212. The memory 202 can comprise any type of volatile or non-volatile memory, shared memory, distributed memory, and in an embodiment, can be non-volatile memory that stores a position mapper software module 114 and an application software module 210.

The processor 204 can be a general purpose or special purpose microprocessor that executes the position mapper software module 114 and the application software module 210. The system bus 212 can comprise the physical and logical connections to couple the above-described elements together and enable their interoperability.

In an embodiment, the position mapper software module 114 executes a number of functions, illustrated as processes or execution threads within the position mapper software module 114.

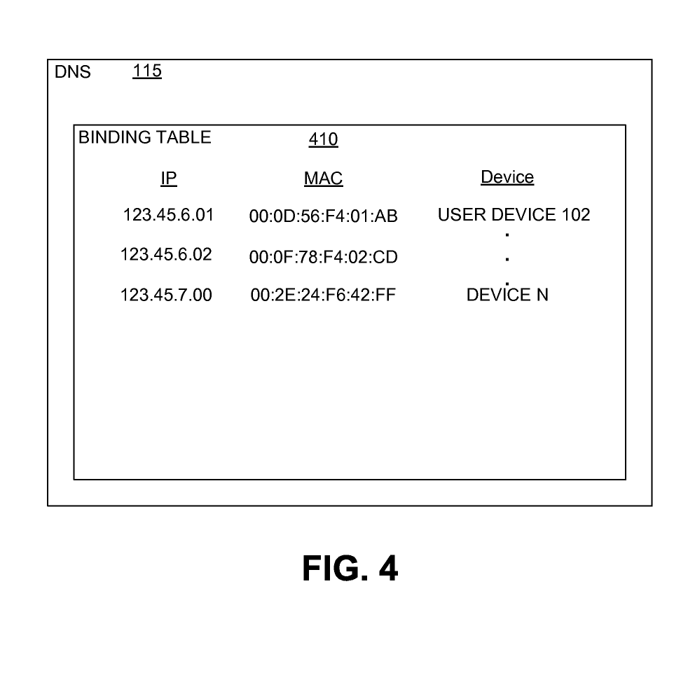

The IP to MAC to Location thread 222 is the thread process that correlates the IP address, MAC address and location to develop the binding table 410 (FIG. 4) and the position mapper sample table 120 (FIG. 1), an instance of each of which is illustrated as being located in the database 206.

The mobile view cache thread 224 is the thread process that stores location information with associated IP addresses and MAC addresses. Storing the location information with associated IP addresses and MAC addresses enables quicker look up of information without having to make a synchronous call to the location engine 116 to get the location information for each query. Multiple instances of the mobile view cache thread 224 may execute simultaneously.

The REST server thread 226 is a process thread that exposes a JavaScript Object Notation (JSON) interface for other third party applications, which allows those third party applications to request location information from the computing device 200 based on an IP address or other information in the mobile view cache thread 224. The term “REST” denotes a “Representational State Transfer” software architecture used for distributed systems, such as the World Wide Web. In an embodiment, the REST server thread 226 can be implemented by a JSON server. Multiple instances of the REST server thread 226 may execute simultaneously.

The mobile view real time tracking “RTT” thread 228 is a process thread that manages the tracking sessions of each user device. Tracking sessions can be maintained for a defined period of time and for a particular MAC address. The two input parameters to the mobile view RTT thread 228 are how often to report the location requests and how long to track a user device. Multiple instances of the mobile view real time tracking “RTT” thread 228 may execute simultaneously.

The location engine interface 232 is a library interface to the location engine 116.

The router 234 can be any router that provides access to the network 106 (FIG. 1) and in general, can be any router that provides Internet access.

The reference time thread 236 provides a timestamp corresponding to the time that a location fix is provided for a particular user device.

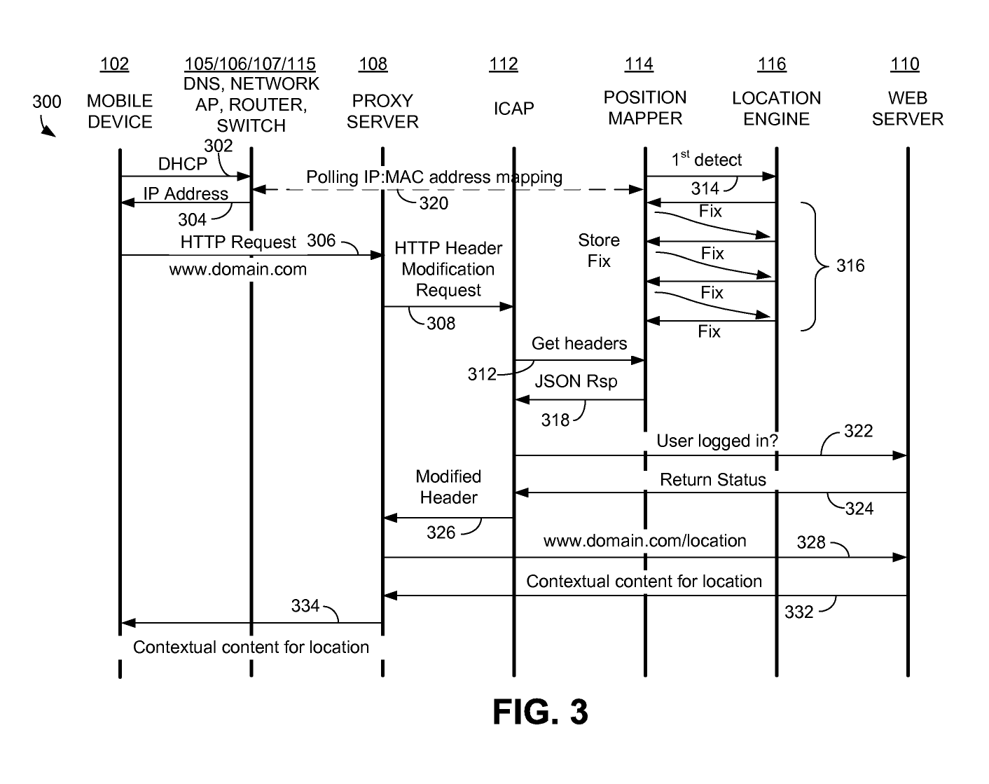

FIG. 3 is a call flow diagram illustrating an embodiment of a method for associating IP address, MAC address and location. The diagram 300 illustrates the operation of various elements in FIG. 1 for reference. As an example, call 302 represents a dynamic host configuration protocol (DHCP) request provided from the user device 102 to the network 106. In FIG. 3, the functionality of the access points 105, the network 106, the router/switch 107 and the DNS 115 are combined for ease of explanation. In response to the call 302, the access point 105a, the router/switch 107 and the network 106 provides a call 304, assigning an Internet Protocol (IP) address to the user device 102, thus allowing the user device 102 to access and communicate over the network 106. The IP address is assigned by the APs 105 and/or the DNS 115 and/or the router/switch 107. The DNS 115 builds an IP:DHCP binding table that associates the IP address assigned to the user device 102 with the MAC address of the user device 102. An example of an IP:DHCP binding table is shown in FIG. 4. The IP:DHCP binding table 410 illustrates the association of an IP address with a MAC address for a particular user device.

The call 306 illustrates an HTTP request for a website (e.g., www.domain.com) made by the user device 102 and forwarded through the network 106 to the proxy server 108. The call 320 represents IP and media access control (MAC) address mapping between the network 106 and the position mapper 114, as described herein.

The call 308 represents the transfer of a request for a modified HTTP header sent from the proxy server 108 to the ICAP element 112. The request for a modified HTTP header is sent from the proxy server 108 over connection 142, and includes context aware metadata pertaining to the context of the user device 102. In an embodiment, the context of the user device can be determined in a number of different ways. In the example shown in FIG. 1, the context of the user device 102 is determined by one or more of the network 106, the proxy server 108, and the web server 110, without any contribution or interaction from the user device 102. In other words, the user device 102 is a standard, unmodified device and any context awareness is determined by elements other than the user device 102. In an embodiment, one or more of the network 106, the proxy server 108, and the server 110 determines the context of the user device 102 based on network parameters.

The call 312 issued between the ICAP element 112 and the position mapper 114 is made over connection 144 to determine the position of the user device 102 and to obtain modified header information.

The call 314 made between the position mapper 114 and location engine 116 over connection 146 refers to a first detection of the location of the user device 102. The immediate polling requests improve the user experience by shortening the perceived time to first fix (TTFF). The calls 316 refer to a series of polling intervals and position location fixes that occur in real-time between the position mapper 114 and the DNS 115, and between the position mapper 114 and the location engine 116 to determine the location of the user device 102 after the initial request by the call 314. The polling intervals can be any duration and, in an example, can be one (1) second. As an example, the position mapper 114 polls the DNS 115 every one (1) second to determine IP:MAC address associations. The position mapper 114 polls the location engine 116 every five (5) seconds for all MAC IDs, location fixes, and timestamps for each location fix. The location engine 116 may have MAC ID, location fix and timestamp information from a previous tracking request. The position mapper 114 may obtain this information from the location engine 116 and map it to the recent IP:MAC address associations received from the DNS 115. The position mapper 114 may obtain a single fix query for a particular MAC ID as well for a device that does not have a current location fix.

The call 318 from the position mapper 114 to the ICAP element 112 includes the location of the user device 102 as determined by the location engine 116. In an embodiment, the call 318 can be a JavaScript object notation (JSON) response and is provided from the position mapper 114 to the ICAP element 112 and refers to the location and related context information of the user device 102. In an embodiment, the location can be referred to as a “geofenced zone” location, which refers to a geographic area that is monitored for the presence of a user device 102 and a user. In an embodiment, such a geofenced zone can comprise an attraction at an amusement facility, a performance venue, or any other area that can be monitored using one or more technologies, such as GPS, radio frequency identification (RFID), video surveillance, etc. The position mapper 114 uses the IP:MAC address association, the location information, and timestamp information to build the table 120.

The call 322 issued from the ICAP element 112 to the web server 110 attempts to determine whether the user is logged in, for example to further retrieve context information from the web server 110.

The call 324 from the web server 110 to the ICAP element 112 contains information on whether the user device 102 is logged in to the web server 110.

The call 326 issued from the ICAP element 112 to the proxy server 108 over connection 142 provides a modified HTTP header to the proxy server 108. The modified HTTP header includes the context aware metadata and also includes the location of the user device 102.

The call 320 represents IP and media access control (MAC) address mapping between the network 106 and the position mapper 114. The position mapper 114 takes the IP address and the MAC address of the user device 102 from the binding table 410 (FIG. 4), and requests location information from the location engine 116 based on the MAC address of the user device 102. The position mapper 114 then associates the location of the user device 102 to the IP address and the MAC address and builds the table 120 (FIG. 1). A timestamp is generated by the reference time thread 236 in the position mapper 114 and is associated with the IP:MAC address association and the location information. The timestamp provides the age of the location fix and is based on a configurable threshold to determine whether a new location fix should be requested. The timestamp can be provided by the local time kept by the computing device 200 in which the position mapper software 114 executes.

All devices in the system 100 need not to be synchronized to the same time source because the position mapper 114 maintains its own timestamp for a position fix regardless of the location engine 116. The timestamp threshold is configurable, where if it determined that the location fix is older than a threshold amount (more than, for example, 1 minute old), a new timestamp is generated. The threshold is based on the intended application and to balance and control the number and frequency of requests to the location engine 116 (FIG. 1). For example, if a position location fix is older than 1 minute in the mobile view cache 224, a new tracking request is initiated to the mobile view RTT thread 228 to obtain updated position information.

The position mapper 114 then returns location information to the ICAP element 112 in call 318, which requested contextual information for the user device 102. In this manner, location information related to the user device 102 is sent back to the ICAP element 112, and the ICAP element 112 provides a modified HTTP header to the proxy server 108 (in call 326) with the location information of the user device 102. In this manner, location information and, to a broader extent, context information related to the user device 102 is added to the HTTP request either explicitly or implicitly.

The call 328 provided from the proxy server 108 to the web server 110 over connection 136 includes a modified HTTP request (e.g., using url modification as shown or using x tag insertion as examples) having context aware metadata and includes the location of the user device 102.

The call 332 from the web server 110 to the proxy server 108 over connection 138 includes location-based contextual content that is tailored to the user based on the location and context of the user device 102. The call 334 provided from the proxy server 108 to the mobile device 102 over connections 134 and 132 includes the context aware content delivered to the user device 102. In this manner, the context of the user device 102 is determined and context specific content is provided from the web server 110 to the user device 102.

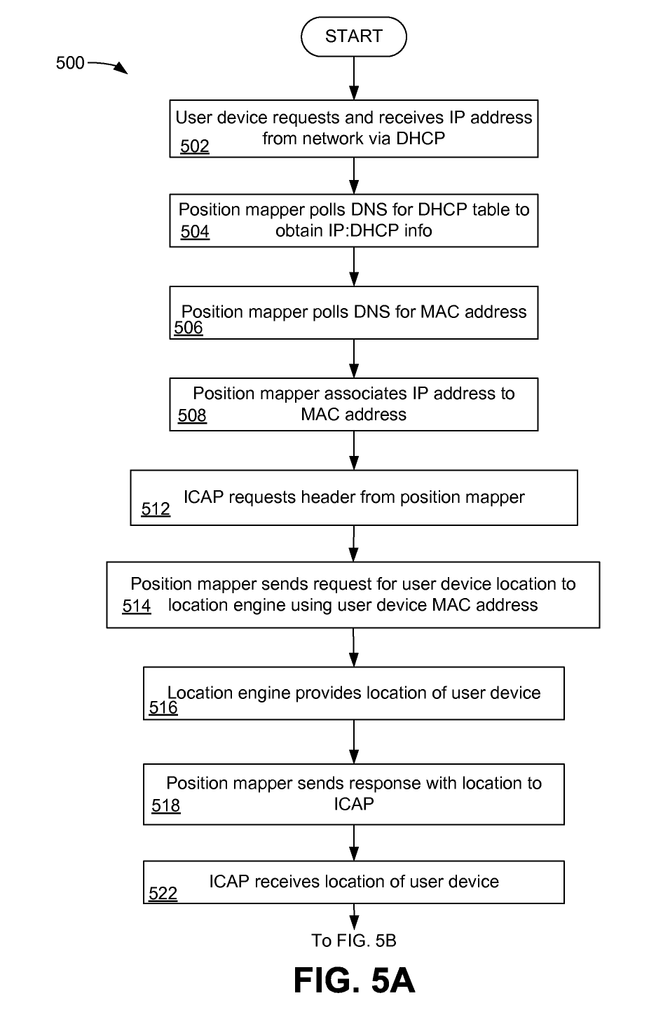

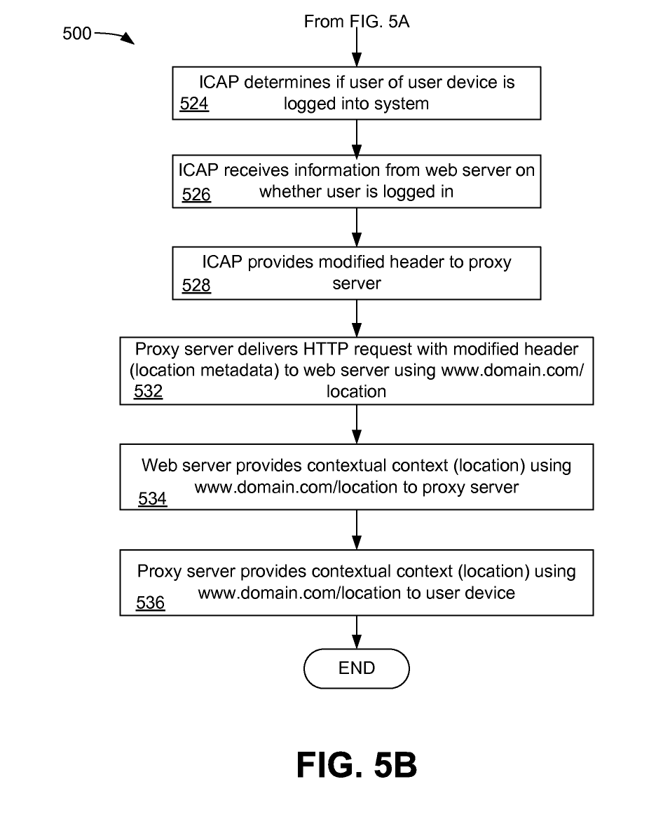

FIGS. 5A and 5B are a flow chart 500 collectively illustrating an embodiment of a method for associating IP address, MAC address and location for a user device.

In block 502, a user device 102 initiates a dynamic host configuration protocol (DHCP) request and sends the request to the DNS 115 either directly or via the router/switch 107, and to the network 106. The DNS 115, router/switch 107 and the network 106 respond with an Internet Protocol (IP) address, thus allowing the user device 102 to access and communicate over the network 106.

In block 504, the position mapper 114 polls the DNS 115 for a DHCP table to obtain the IP to DHCP bindings for the user device 102.

In block 506, the position mapper 114 polls the DNS 115 for the MAC address of the user device 102.

In block 508, the position mapper 114 associates the IP address and the MAC addresses and builds the table 120 (FIG. 1).

In block 512, the ICAP element 112 requests a header from the position mapper 114 for the contextual information of the user device 102 by IP address and to obtain information to modify the HTTP request.

In block 514, the position mapper 114 sends a request for the location of the user device 102 to the location engine 116 using the MAC address of the user device 102.

In block 516, the location engine 116 provides the location of the user device 102.

In block 518, the position mapper 114 timestamps the location fix received from the location engine 116 and sends a response in the form of a JSON response to the ICAP element 112 with the location of the user device 102.

In block 522, the ICAP element 112 receives the location of the user device 102.

In block 524, the ICAP element 112 determines if the user device 102 is logged in to the web server 110.

In block 526, the ICAP element 112 receives information on whether the user device 102 is logged in to the web server 110.

In block 528, the ICAP element 112 provides a modified HTTP header to the proxy server 108. The modified HTTP header includes the context aware metadata and also includes the location of the user device 102.

In block 532, the proxy server 108 delivers the modified HTTP request to the web server 110. The modified HTTP request includes context aware metadata and the location of the user device 102.

In block 534, the web server 110 provides content to the proxy server 108, the content including contextual content for the location and context of the user device 102.

In block 536, the proxy server 108 provides the context aware content to the user device 102.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method for associating an Internet Protocol (IP) address, a media access control (MAC) address and a location for a user device, comprising:
receiving IP to DHCP (dynamic host configuration protocol) bindings related to a user device from a domain name server (DNS);
receiving a MAC address related to the user device from the DNS;
associating the IP address and the MAC address for the user device;
using the MAC address to obtain a geographic location of the user device;
building a table having the IP:MAC address association, the location of the user device and a timestamp corresponding to the IP:MAC address association and the location of the user device; and
using the IP:MAC address association and the location of the user device to deliver contextual content to the user device.

2. The method of claim 1, wherein the contextual content is determined, at least in part, by the location of the user device.

3. The method of claim 1, wherein the IP to DHCP bindings, MAC address and location of the user device are received periodically in real-time.

4. The method of claim 1, wherein using the IP:MAC address association and the location of the user device to deliver contextual content to the user device is independent of an IP address of the user device by decoupling the IP address of the user device from the location determination technology.

5. The method of claim 1, further comprising using the IP address of the user device to determine the MAC address of the user device.

6. The method of claim 5, wherein the MAC address of the user device is used to determine a location of the user device.

7. The method of claim 6, further comprising using the location of the user device as metadata to modify a request for content.

8. A system for associating an Internet Protocol (IP) address, a media access control (MAC) address and a location for a user device, comprising:
a position mapper element for receiving IP to DHCP (dynamic host configuration protocol) bindings related to a user device from a domain name server (DNS);
the position mapper element receiving a MAC address related to the user device from the DNS;
the position mapper element associating the IP address and the MAC address for the user device;
a location engine for using the MAC address to obtain a geographic location of the user device;
the position mapper element building a table having the IP:MAC address association, the location of the user device and a timestamp corresponding to the IP:MAC address association and the location of the user device; and
a server for using the IP:MAC address association and the location of the user device to deliver contextual content to the user device.

9. The system of claim 8, wherein the contextual content is determined by the location of the user device.

10. The system of claim 8, wherein the IP to DHCP bindings, MAC address and location of the user device are received periodically in real-time.

11. The system of claim 8, wherein using the IP:MAC address association and the location of the user device to deliver contextual content to the user device is independent of an IP address of the user device by decoupling the IP address of the user device from the location determination technology.

12. The system of claim 8, wherein the IP address of the user device determines the MAC address of the user device.

13. The system of claim 12, wherein the MAC address of the user device determines a location of the user device.

14. The system of claim 13, wherein the location of the user device comprises metadata to modify a request for content.

15. A method for determining a location of a user device, comprising:
receiving IP to DHCP (dynamic host configuration protocol) bindings related to a user device from a domain name server (DNS);
receiving a MAC address related to the user device from the DNS;
associating the IP address and the MAC address for the user device;
using the MAC address to obtain a geographic location of the user device;
building a table having the IP:MAC address association, the location of the user device and a timestamp corresponding to the IP:MAC address association and the location of the user device; and
using the IP:MAC address association and the location of the user device to deliver contextual content to the user device wherein the contextual content is determined, at least in part, by the location of the user device.

16. The method of claim 15, wherein the IP to DHCP bindings, MAC address and location of the user device are received periodically in real-time.

17. The method of claim 15, wherein using the IP:MAC address association and the location of the user device to deliver contextual content to the user device is independent of an IP address of the user device by decoupling the IP address of the user device from the location determination technology.

18. The method of claim 15, wherein the IP address of the user device determines the MAC address of the user device.

19. The method of claim 18, wherein the MAC address of the user device determines a location of the user device.

20. The method of claim 19, wherein the location of the user device comprises metadata to modify a request for content.
